(19) United States
(12) Patent Application Publication
(10) Pub. No.: US 2008/0309900 A1
(43) Pub. Date: Dec. 18, 2008

(54) Method of making patterning device, patterning device for making patterned structure, and method of making patterned structure

(75) Inventors: Steve Oliver, Boise, ID (US); Ulrich Boettiger, Boise, ID (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 11/808,702

(22) Filed: Jun. 12, 2007

(51) Int. Cl. G03C 5/16; B29C 65/48; G03B 27/42

(52) U.S. Cl. 355/53; 156/247; 430/321; 430/322; 430/324

(57) ABSTRACT

A method and apparatus to fabricate a patterned structure using a template supported on a carrier. The method includes patterning a material to conform to the patterned structure. The patterned material is cured while remaining on the template. The carrier is removable during the curing process. The template is later removed from the patterned material to obtain the patterned structure. A patterning device is also provided, which is formed by a template and a carrier releasably attached to each other. The template and the carrier can be separated from each other when the patterning device is subjected to curing of the patterned structure.

### FIELD OF THE INVENTION

The invention relates to the field of patterning technologies for making patterned structures, including microstructures and/or nanostructures.

### BACKGROUND OF THE INVENTION

Patterning technologies have been widely used to manufacture patterned structures for applications in electrical, electronic, optical, photonic, biological, and other devices. Recently, imprint technology has been developed for fabricating molecular structures, microstructures, and/or nanostructures, which can be used in various devices from simple optical elements to integrated circuits as well as electronics and semiconductor components and devices, including metal-oxide-semiconductor field-effect transistors (MOSFET), organic thin-film transistors (O-TFT), microlens arrays, single electron memories, semiconductor-based image sensors, data storage devices, displays, imaging systems, and other devices.

In an imprinting process, a master is typically provided with a pattern to be replicated. The master can be formed by a high resolution patterning technique, such as electron beam lithography, such that it achieves a high resolution pattern. The master can then be used to create a corresponding pattern in an electronics component, such as by stamping, printing, molding, or other techniques. In the alternative, the master can be used to pattern a template, which in turn transfers the pattern from the master onto an electronics or optical component.

When using a template in an imprinting process, additional measures are taken to support the template, such as during its formation or when the template transfers its pattern to a substrate layer to form a patterned structure. Applicants recognized that, in doing so, additional process steps must be carefully employed to release the template from the patterned structure and reduce the risk of damage to the template and/or patterned structure. Thus, a simplified imprinting process and patterning device is desirable.

### BRIEF DESCRIPTION OF THE DRAWINGS

FIGS. 1A to 1H illustrate one embodiment of a method of making a patterning device, in which FIGS. 1F to 1H show patterning devices so formed.

FIGS. 2A to 2F illustrate one embodiment of a method of making a patterned structure using a patterning device as shown in FIG. 1F.

FIGS. 3A to 3E illustrate another embodiment of a method of making a patterned structure using a patterning device as shown in FIG. 1F.

FIGS. 4A to 4F illustrate a further embodiment of a method of making a patterned structure using a patterning device as shown in FIG. 1F.

FIGS. 5A to 5E illustrate a still further embodiment of a method of making a patterned structure using a patterning device as shown in FIG. 1F.

FIG. 6 is a block diagram of an imaging device containing a patterned structure constructed in accordance with one of the embodiments.

FIG. 7 is an illustration of an imaging system comprising the imaging device formed in accordance with one of the embodiments.

### DETAILED DESCRIPTION OF THE INVENTION

In the following detailed description, reference is made to the accompanying drawings, which form a part hereof and show by way of illustration specific embodiments and examples in which the invention may be practiced. These embodiments and examples are described in sufficient detail to enable those skilled in the art to practice them. It is to be understood that other embodiments and examples may be utilized, and that structural, logical, and electrical changes and variations may be made. Moreover, the progression of processing steps is described as an example; the sequence of steps is not limited to that set forth herein and may be changed, with the exception of steps necessarily occurring in a certain order.

Various embodiments will now be described with reference to the figures, in which similar components and elements are designated with reference numerals having the same last two numerical digits and redundant description is omitted. The following embodiments describe a method of making patterning devices for use in an imprinting process, a patterning device for making patterned structures, and a method of making patterned structures. The following embodiments can simplify the imprinting process and/or reduce the risk of damaging or distorting the resulting patterned structures.

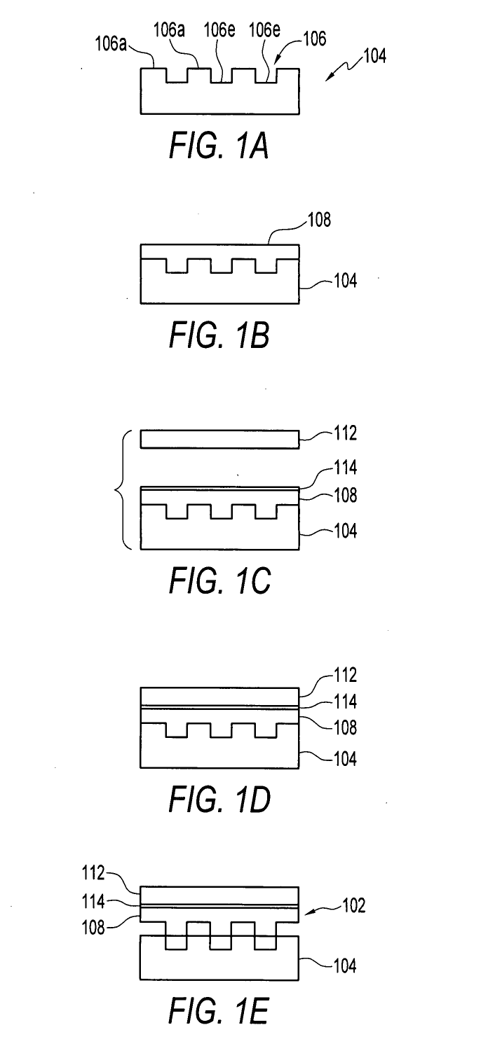

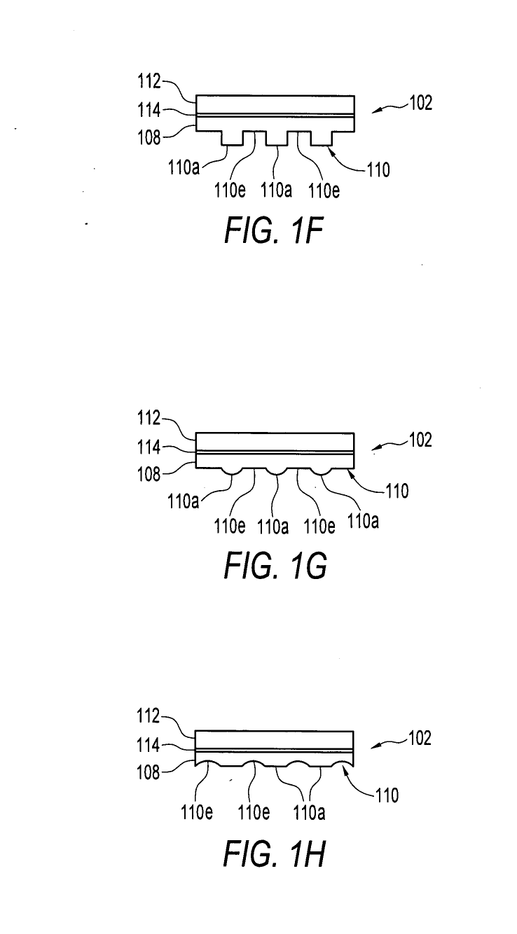

FIGS. 1A to 1F illustrate one embodiment of a method of making a patterning device 102, which is best depicted in FIG. 1F. As FIG. 1A shows, a master device 104 having a predetermined master pattern 106 is first provided, which can be formed by any of various methods. For example, the master device 104 can be formed by a high resolution lithographic technique, such as electron beam lithography. The master device 104 can be formed of any of various rigid materials, such as a silicon, silicon-on-insulator (SOI), germanium, quartz, glass, borosilicate, GaAs, SiGe, GaN, GaP, InP, metals, such as stainless steel, iron, copper, or aluminum, and other materials. The predetermined master pattern 106 can have various configurations, such as including raised patterns 106a and recessed patterns 106e, which are to be transferred onto an imprint material as will be described in greater detail below.

The master device 104 is then replicated to form a template 108 containing a transferred pattern 110 (see FIG. 1F) corresponding to the predetermined master pattern 106 on the master device 104. As is shown in FIG. 1B, a suitable material for forming the template 108 can be deposited over the master device 104 by any of various methods. For example, the template material can be made to conform to the predetermined pattern 106 by coating (e.g., spin coating, and spray coating), dispensing, injecting, molding, or other deposition methods. In one example, the template material is deposited over the predetermined pattern 106 on the master device 104 by spin coating. As those skilled in the art will appreciate, the spin coating technique can provide a simplified fabrication process to form a substantially conforming material layer with minimal costs. After the template material is conformed to the predetermined pattern 106 on the master device 104, the template material can be cured to stabilize the transferred pattern 110 formed on the template 108. Those skilled in the art will appreciate that various other methods can be used to form the transferred pattern 110 on the template 108.

The template 108 can be made of any of various suitable template materials. For example, the template material can be chosen to facilitate the formation and/or ensure the desired resolution of the template 108. In one example the template 108 can be formed of a polymer material that can adequately conform to the predetermined pattern 106 on the master device 104. In another example, the template material is chosen to allow the formed template 108 to be detached from the master device 104 without causing damage or distortion to the template 108 after it is patterned by the master device 104.

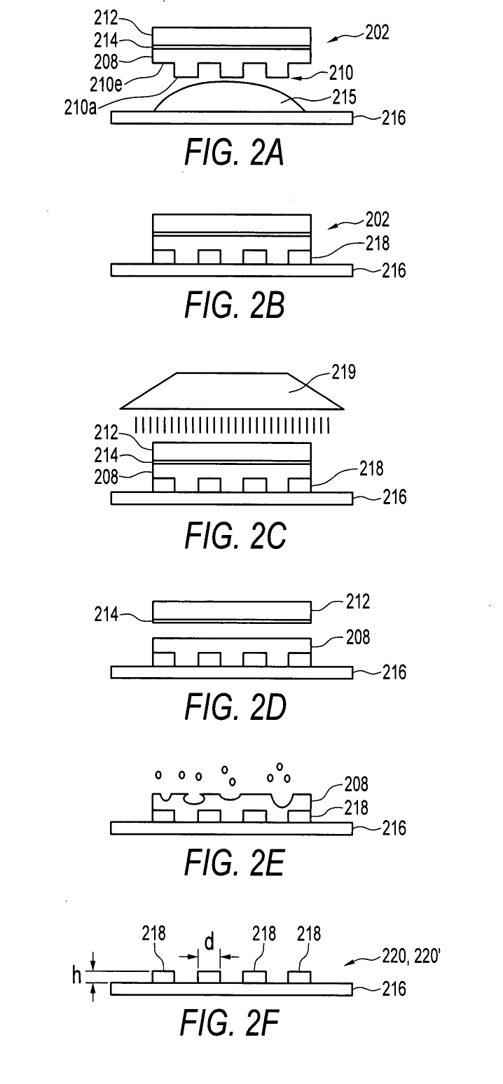

Additionally or alternatively, the template material can be determined to facilitate the fabrication of patterned structures 220, 320, 420, 520 (see FIGS. 2F, 3E, 4E, and 5E, respectively). For example, the template 108 can comprise a material that allows the operation of any of various imprinting methods as described below. In one embodiment, the template material is transparent to ultraviolet radiation. The template 108 so formed can allow ultraviolet light to pass therethrough to cure the patterned imprint material during an ultraviolet imprinting process to fabricate patterned structures 220, 420. In another embodiment, the template materials are those that can withstand the heat used during a thermoplastic imprinting or a hot embossing process. For example, the template material can be a non-thermoplastic material. The template material so chosen can enable the template 108 to maintain its transferred pattern 110 during the imprinting process without causing deformation or distortion to the patterned structures 320, 520 under formation.

In a further embodiment, the template material can be so determined to allow the template 108 to be readily removed after the formation of the patterned structures 220, 320, 420, 520. In one example, the template 108 is made of a metal material, which can be dissolved by a wet etching process. In another example, the template material can be formed of any of various dissolvable materials so that the template 108 can be dissolved and removed from the patterned structures 220, 320, 420, 520 after the imprinting process. For example, the template material can be a solvent based dissolvable material. In a desired embodiment, the template 108 is formed of a polyvinyl alcohol (PVA) material, which is dissolvable in water.

Examples of template materials can include polydimethylsiloxane (PDMS), polyvinyl alcohol (PVA), non-thermoplastic polymer or other polymer materials, and nickel plated layer or other plating materials. Those skilled in the art will appreciate that various other template materials can also be used to form the template 108.

After the template 108 is formed with the transferred pattern 110, the template 108 is removed from the master device 104. As FIG. 1C shows, a carrier 112 can be provided to facilitate the removal of the template 108. The carrier 112 can be formed of any of various materials to provide support to the template 108, such as throughout the template removal process and/or at least partially during the later imprinting process of the patterned structures 220, 320, 420. The carrier 112 can be formed to be flexible or rigid and/or as a plastic or glass material. In one example, the carrier 112 is formed of the same material, such as a polymer, used to form the template 108. In another example, the carrier 112 is formed of a material more rigid than the template material to provide additional rigidity and stiffness to the template 108. Such a carrier 112 is capable of counteracting external forces exerted on the template 108 and maintaining the transferred pattern 110 during the imprinting process. For example, the carrier 112 may be a glass substrate.

Additionally or alternatively, the carrier 112 can be formed of any of various materials that allow the operation of one or more imprinting methods of making patterned structures 220, 320, 420. In one embodiment, the carrier material is transparent to ultraviolet radiation, so that the resulting carrier 112 can be used in an ultraviolet radiation curing process to form patterned structures 220, 420 as is described in greater detail below. In another embodiment, the carrier 112 is made of a material that can withstand the heating treatment when the carrier 112 is used in a thermoplastic imprinting process to form the patterned structures 220, 320, 420. Those skilled in the art will appreciate that various other materials can also be used to form the carrier 112.

The carrier 112 can be temporarily releasably attached to the template 108. For example, the carrier 112 can be attached to, and support, the template 108 during the template removal process. The carrier 112 can also be attached to the template 108 at least through part of the imprinting process to form the patterned structures 220, 320, 420. In one example, the carrier 112 can be temporarily bonded to the template 108 through a releasable bonding layer 114. The temporary releasable bonding can also allow the carrier 112 to be later separated and removed from the template 108 without compromising the integrity of the carrier 112 and/or the template 108. In one embodiment described below, the carrier 112 is separated from the template 108 when the bonding layer 114 is released at the same time the imprint material is being cured.

The bonding layer 114 can be any of various releasable adhesive materials. For example, the adhesive materials can be in various forms, such as a liquid (e.g., waxes), tapes, preformed dry-film layer, and other forms. In one example as described below, the bonding layer 114 is a preformed adhesive layer having a uniform thickness in the range from about 25 μm to about 100 μm.

The adhesive materials can be any of various ultraviolet, thermal, and solvent release adhesives, such as a UV or thermally releasable epoxy. In one example, the bonding layer 114 is formed of an ultraviolet release adhesive material, which becomes at least partially inactive or otherwise loses adhesion to be inoperable as an adhesive material after being exposed to ultraviolet radiation. For example, the bonding layer 114 can be formed of a conventional ultraviolet releasable adhesive or UV-releasable tape such as “SP-589M-130” from Furukawa Electronic, Co., Ltd. of Japan.

In another example, the bonding layer 114 is formed of a thermal release adhesive material, which becomes at least partially inactive or inoperable as an adhesive material after being subjected to heat. For example, the thermal release bonding layer 114 can be formed to be releasable at the same temperature used to cure an imprint material patterned by the template 108 as will be described below. In such a case, the template 108 can be separated from the carrier 112 during the curing process when the bonding layer 114 is released. In the alternative, the thermal release bonding layer 114 can be formed to be releasable at a temperature different from or higher than that used in the curing process. When the releasing temperature of the bonding layer 114 is higher than the curing temperature, the carrier 112 can support the template 108 throughout the curing process and the template removal process.

The thermal release bonding layer 114 can be formed of any of various thermal release adhesive materials. In one example, the bonding layer 114 can be formed of a conventional thermal releasable adhesive material sold under the trademark “WaferBOND™” by Brewer Science, Inc. of Rolla, Mo. In a desired example, the bonding layer 114 can be formed of a conventional thermal releasable adhesive tape labeled as “REVALPHA” and made by Nitto Denko Corporation of Japan. Those skilled in the art will appreciate that the bonding layer 114 can be formed of releasable adhesive materials of various other kinds and/or be in various other forms.

In an example as shown in FIG. 1C, the bonding layer 114 can be provided on an exposed surface of the template 108 by any of various methods. For example, the bonding layer 114 can be deposited on top of the template 108 by, e.g., spin coating. In one example, the bonding layer 114 can have a uniform thickness. In another example, the bonding layer 114 can be a preformed film layer, which can be laid on the exposed surface of the template 108 by a rolling process. The bonding layer 114 can thereby bond the template 108 and the carrier 112 to each other when they are brought together and pressed against each other, as is shown in FIG. 1D. As those skilled in the art will appreciate, the bonding layer 114 can also be provided on the carrier 112 and bonded to the template 108 when the carrier 112 and the template 108 are pressed against each other.

FIG. 1E shows the template 108 being lifted and separated from the master device 104 with the aid of the carrier 112. To aid in releasing the template 108, the master device 104 can be provided with a non-stick coating, such as a polytetrafluoroethylene, or parylene coating. The patterning device 102 is thereby obtained with the template 108 being supported by the carrier 112. The master device 104 can be reused to make one or more additional patterning devices 102.

FIG. 1F shows that the formed patterning device 102 contains the transferred pattern 110, which is a negative replica of the predetermined pattern 106 on the master device 104. For example, the transferred pattern 110 on the patterning device 102 includes raised patterns 110a resulting from the recessed patterns 106e on the master device 104. The recessed patterns 110e on the patterning device 102 are created by the raised patterns 106a on the master device 104. The transferred pattern 110 on the patterning device 102 can be used to form various patterned structures 220, 320, 420 having replicated patterns of the predetermined pattern 106 on the master device 104. Although the figures show that the raised patterns 110a (or recessed patterns 110e) are formed to have the same configuration as each other, they can be formed to have different shapes or sizes to result in varied configuration in the patterned structures 220, 320, 420.

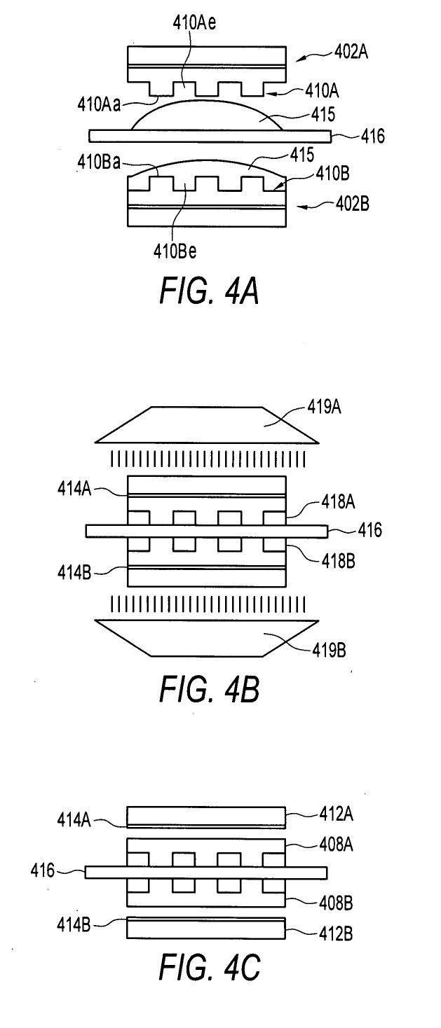

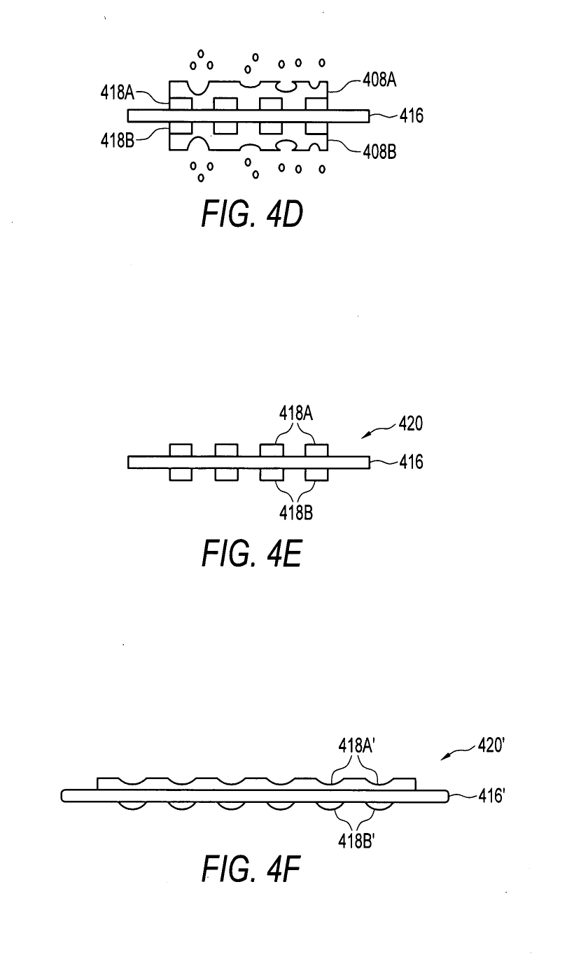

FIGS. 1G and 1H show that the raised and recessed patterns 110a, 110e on the patterning device 102 can be formed to have various other configurations, such as to have a convex or concave contour. In one example, the raised patterns 110a can have a convex shape, as is shown in FIG. 1G, to form concave conformed patterns, such as the conformed patterns 418A′ in a lens or microlens array 420′ shown in FIG. 4F. In another example, the recessed patterns 110e on the patterning device 102 are formed to have a concave shape, as is shown in FIG. 1H. Such concave patterns 110e can form convex conformed patterns, such as the conformed patterns 418B′ in a lens or microlens array 420′ shown in FIG. 4F. As those skilled in the art will appreciate, the raised and recessed patterns 110a, 110e as well as the transferred pattern 110 can be formed in various other ways to result in desired patterned structures 220, 320, 420.

Various methods of making patterned structures 220, 320, 420 using the patterning device 102 formed as described above are now described.

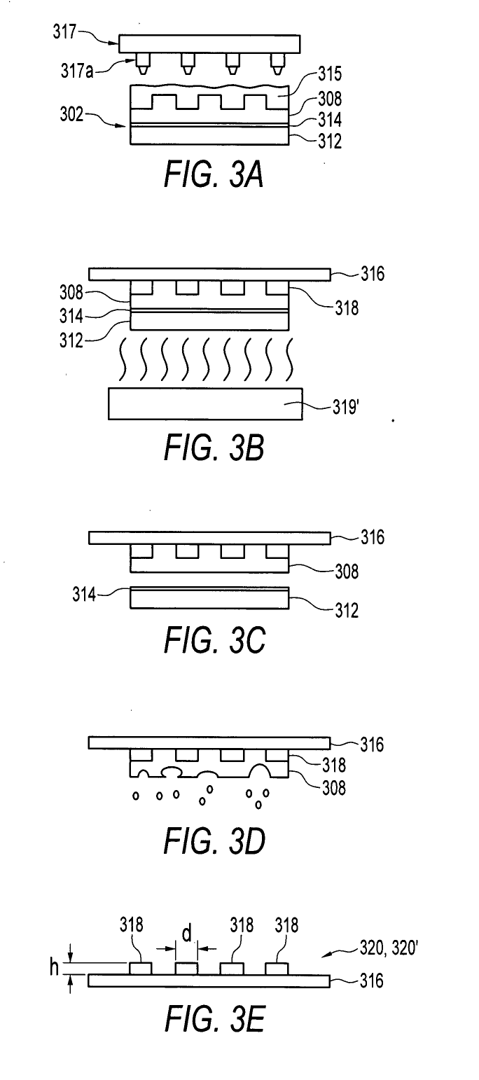

FIGS. 2A to 2F illustrate a first embodiment for forming a patterned structure 220, as is shown in FIG. 2F, by an imprinting process. As FIG. 2A shows, a patterning device 202 contains a transferred pattern 210 provided to pattern an imprint material 215. Both the template 208 and the carrier 212 of the patterning device 202 can be formed to be transparent to ultraviolet radiation and bonded to each other by an ultraviolet releasable bonding layer 214. Although the patterning device 202 is adapted for use in an ultraviolet imprinting process, those skilled in the art will appreciate that the patterning device 202 can also be constructed for use in a thermoplastic imprinting process, similar to the patterning device 302 described below in connection with FIGS. 3A to 3E.

Various imprint materials 215 can be used in the imprinting process to form the patterned structure 220. For example, the imprint material 215 can be of any various materials capable of conforming to the transferred pattern 210 on the patterning device 202 and achieving the required resolution in the resulting patterned structure 220. Additionally or alternatively, the imprint material 215 can be chosen depending on the desired application of the formed patterned structure 220.

In one embodiment, the imprint material 215 can be any of transparent glass or polymer materials suitable for making a lens structure, such as image objective lenses or microlens arrays. Examples of suitable lens materials can include, but are not limited to, acrylic polymers with cross-linking components such as certain hydroxyl, epoxy, and amino compounds that may cross-link with one another, silicones, particularly organosilicons, and polysiloxanes. Suitable materials can also include substantially colorless polyimide and perfluorocyclobutane containing ether polymers. Those skilled in the art will appreciate that various other imprint materials 215 can also be used to form the patterned structure 220.

Various methods can be used to conform the imprint material 215 to the transferred pattern 210 on the patterning device 202. For example, a molding technique can be used to transfer the pattern 210 to the imprint material 215. In one example as is shown in FIG. 2A, an imprint material 215 can be first deposited onto a supporting layer 216. The imprint material 215 and the patterning device 202 are then moved toward each other, as is shown in FIG. 2A. In one example, the imprint material 215 and the patterning device 202 are aligned before contacting each other.

The supporting layer 216 is adapted to provide support to the imprint material 215, such as during the molding process and/or other process steps of the imprinting process as will be described below. For example, the supporting layer 216 is formed of a rigid material, such as glass. In one example, the supporting layer 216 can have a planar supporting surface, on which the imprint material 215 can be deposited, to thereby reduce the irregular topography in the resulting patterned structure 220.

FIG. 2B illustrates the patterning device 202 being forced against the imprint material 215 causing the same to deform and conform to the raised and recessed patterns 210a, 210e on the patterning device 202 to form the conformed patterns 218 in the imprint material 215. As is shown in FIG. 2B, the patterning device 202 is forced toward the supporting layer 216 until one or more of the raised patterns 210a on the patterning device 202 contact the supporting layer 216. The molding process can also be performed in a conventional imprinting tool so as to provide additional control of the height h of the resulting conformed patterns 218. In another example (not shown), a thin layer of imprint material 215 can remain between the raised patterns 210a of the patterning device 202 and the supporting layer 216 so that the conformed patterns 218 formed in the imprint material 215 are interconnected through the thin layer of the imprint material 215. Those skilled in the art will appreciate that various other methods can also be used to transfer the pattern 210 on the patterning device 202 to the imprint material 215.

Although FIG. 2B shows the conformed patterns 218 being formed on a portion of a substrate (e.g., the supporting layer 216), those skilled in the art will appreciate that the conformed patterns 218 can be formed throughout substantially an entire substrate, for example, an entire wafer substrate used in the fabrication of integrated circuits. In one example, the conformed patterns 218 are formed over an entire substrate, e.g., a wafer substrate, in a single imprinting process step to improve throughput and uniformity of the conformed patterns 218.

In FIG. 2C, the conformed patterns 218 formed in the imprint material 215 can be cured by any of various methods. In one embodiment, the conformed patterns 218 are subjected to ultraviolet radiation which passes through carrier 212 and template 208. For example, an ultraviolet radiation source 219 can be provided to generate ultraviolet light being directed to the conformed patterns 218. The ultraviolet radiation passes through the carrier 212, and the template 208 and causes the polymeric imprint material 215 of the conformed patterns 218 to be crosslinked and create a polymer system. The conformed patterns 218 can thus be afforded sufficient mechanical strength and chemical stability to allow them to be separated from the patterning device 202 and incorporated into various electronics, semiconductor, or optical, or other components and devices in later processes.

During the process of curing by ultraviolet radiation, the bonding layer 214, which is formed of an ultraviolet releasable adhesive material, can gradually be debonded from one of the template 208 and the carrier 212 to subsequently cause the separation of the two, as is shown in FIG. 2D. No additional process step is needed to separate or remove the carrier 212 from the template 208. The process steps described hereinabove can reduce damage or distortion to the conformed patterns 218 caused by traditional debonding techniques, such as lifting, sliding, and peeling. The resulting patterned structure 220 should have improved accuracy.

As is shown in FIG. 2E, the template 208 is next removed by any of various methods. For example, the template 208 can be dissolved, such as in a solvent suitable for dissolving the template material. In one example where the template 208 is formed of polyvinyl alcohol (PVA), the template 208 can be dissolved in water. For example, the PVA template 208, along with the conformed patterns 218 and the supporting layer 216, can be immersed in a water bath (not shown) to allow the template 208 to completely dissolve and be removed from the conformed patterns 218. The freed conformed patterns 218 can be retrieved from the water bath while remaining supported on the glass supporting layer 216 for use in later process steps. Those skilled in the art will appreciate that various other methods can also be used to remove the template 208 from the conformed patterns 218.

FIG. 2F shows a patterned structure 220 formed by the above-described imprinting process and containing a plurality of conformed patterns 218 supported on the supporting layer 216. As one skilled in the art will appreciate, the patterned structure 220 shown in FIG. 2F can be a portion of or an entire patterned substrate, e.g., wafer substrate, containing conformed patterns 218 formed throughout substantially the entire substrate. The patterned wafer substrate can be used as a single component or device, such as an optical disk. Alternatively, the wafer substrate can be so patterned to include multiple groups (i.e., “dies”), which can be dissected into multiple segments for multiple uses. Each die can contain a plurality of conformed patterns 218, such as shown in FIG. 2F, or a single conformed pattern 218. One skilled in the art will appreciate that various other arrangements can be adopted to form a patterned wafer substrate with multiple dies.

The patterned structure 220 can be any of various macrostructures, microstructures, and/or nanostructures for use in various electronics, semiconductor, or optical, or other components and devices. In one example, the patterned structure 220 can be formed over an entire wafer substrate (e.g., the supporting layer 216) that is used as or in an electronics and semiconductor component and device. In another example, the patterned structure 220 can be formed on an optical disk (not shown), in which the conformed patterns 218 form the pits and one or more grooves formed to carry the audio and video information stored on the optical disk.

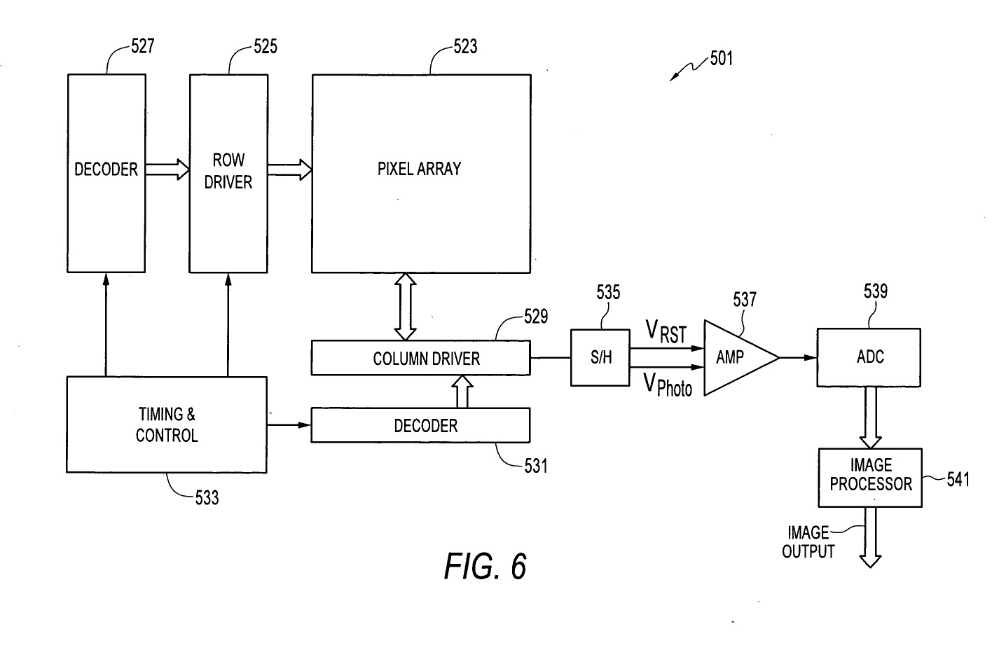

In another example, the conformed patterns 218 formed on an entire wafer can be dissected and then be individually used. For example, each of the conformed patterns 218 in the patterned structure 220 can be formed as an image objective lens for use in an imaging device 501 (see FIG. 6), such as to improve the optical performance of the imaging device 501. In one example, the conformed patterns 218 can be formed to have a convex or concave contour, such as that of the conformed patterns 418A′, 418B′ shown in FIG. 4F.

In a further embodiment, the patterned structure 220 can include one or more microlens arrays 220′ to be used in association with a pixel array 523 (see FIG. 6) of an imaging device 501. For example, the plurality of conformed patterns 218 within each die can be arranged to form a microlens array 220′, while each conformed pattern 218 is formed as a microlens and associated with a pixel cell. The microlens array 220′ can effectively focus incident light impinged on to the pixel array 523 so that the incident light can be absorbed by pixel photosensors more efficiently. Those skilled in the art will appreciate that the conformed patterns 218 and the patterned structure 220 can have various other shapes, configurations, and/or arrangements for use in other electronics and semiconductor components and devices as discussed below.

The conformed patterns 218 in the patterned structure 220 can be formed of any of various dimensions. As is shown in FIG. 2F, the conformed patterns 218 can have a height (h) and one or more lateral dimensions (d). In an embodiment where the conformed patterns 218 are formed as image objective lenses, the height (h) can be in the range from about 50 μm to about 500 μm, or up to about 1000 μm. Additionally or alternatively, the lateral dimension (d) can be in the range from about 500 μm to about 3 mm, or from about 500 μm to about 2 mm. For example, the lateral dimension (d) is a diameter of about 300 μm, 500 μm, 1 mm, or 2 mm. Those skilled in the art will appreciate that the various dimensions of the conformed patterns 218 can be altered, depending on various design factors.

FIGS. 3A to 3E illustrate a second embodiment of a method of making a patterned structure 320 (see FIG. 3E). The various components of the patterning device 302 and process steps employed in this embodiment are shown in the figures, but description of the components and process steps similar to those in the above embodiments is omitted.

In this embodiment, the template 308 and the carrier 312 of the patterning device 302 can be formed to withstand heating applied when curing the imprinting material. The bonding layer 314 can be formed of such a thermal releasable adhesive material that, as the imprint material 315 cures, the carrier 312 can be easily released from the template 308.

As FIG. 3A shows, an imprint material 315 is deposited over the patterning device 302 by any of various micro-scale liquid dispensing techniques, such as jet dispensing. For example, a jet nozzle assembly 317 is employed, which contains an imprint material 315 in a liquid or otherwise flowable form. The nozzle assembly 317 is formed with nozzle ports 317a through which the imprint material 315 can be ejected and deposited over the template 308. In one example, the imprint material 315 is dispensed under a pressure to conform to the template 308. Although FIG. 3A shows that the imprint material 315 is deposited over an upwardly facing template 308, a downwardly facing template can be similarly coated by the same technique.

A supporting layer 316 can be used to assist in forming the conformed patterns 318, as is shown in FIG. 3B. For example, the supporting layer 316 can be pressed onto the imprint material 315 deposited over the patterning device 302 resulting in the conformed patterns 318.

FIG. 3B shows that the conformed patterns 318, along with the patterning device 302 and the supporting layer 316, are subjected to a heat source 319′ to cure the imprint material 315. During the heat treatment, the thermal release bonding layer 314 debonds from one of the template 308 and the carrier 312, so that the carrier 312 is separated and thus removed from the template 308 as is shown in FIG. 3C. A template dissolving process (such as the one described above with respect to FIG. 2E) can be employed to remove the template 308 from the conformed patterns 318 (FIG. 3D). The resulting patterned structure 320 (e.g., a lens or microlens array 320′) is shown in FIG. 3E.

FIGS. 4A to 4F illustrate a third embodiment of a method of making a patterned structure 420 (see FIG. 4E) and a lens or microlens array 420′ (see FIG. 4F). The various components of the patterning device 402A, 402B and process steps employed in this embodiment are shown in the figures, but the description of the components and process steps similar to those in the above embodiments is omitted.

In this embodiment, the patterning device 402A, 402B is in the form of a pair of template assemblies as is shown in FIG. 4A. The template assemblies 402A, 402B can be formed alike and similarly to one of the patterning devices 102, 202, 302 described above. For example, both of the template assemblies 402A, 402B are formed the same as is the patterning device 202 for use in an ultraviolet imprinting process. In the alternative, the template assemblies 402A, 402B can be both formed to be suitable for use in a thermoplastic imprinting process. The template assemblies 402A, 402B so formed can allow the use of a single type of curing source to cure both conformed patterns 418A, 418B. In a desired embodiment, a double-curing process can be employed to cure the conformed patterns 418A, 418B (see FIG. 4B) simultaneously, which can increase fabrication throughput.

The template assemblies 402A, 402B can be formed to have various transferred patterns 410A, 410B to form patterned structures 420 of different configurations. In one example, the transferred patterns 410A, 410B can be formed to have the same pattern, which can then form a patterned structure 420 with symmetric conformed patterns 418A, 418B positioned on the opposite sides of a supporting layer 416 (see FIG. 4E). In another example, the transferred patterns 410A, 410B can be formed to have different patterns to result in, e.g., respectively convex and concave conformed patterns 418A′, 418B′ (see FIG. 4F). Those skilled in the art will appreciate that the transferred patterns 410A, 410B in the template assemblies 402A, 402B can be formed to have various other patterns to obtain patterned structures 420 having desired configurations.

To form the patterned structure 420, imprint materials 415 can be deposited over the template assemblies 402A, 402B by any of various conforming methods, such as the above described molding or micro-scale liquid dispensing (e.g., jet coating) techniques. For example, the imprint materials 415 can be deposited over one or both of the template assemblies 402A, 402B by jet coating, as is described above. In one example, the jet coating is carried out after the template assemblies 402A, 402B are so positioned that their respective transferred patterns 410A, 410B face toward each other, similar to those shown in FIG. 4A. If desired, jet coating can be carried out to deposit imprint materials 415 onto the template assemblies 402A, 402B simultaneously. In another embodiment as is shown in FIG. 4A, the imprint materials 415 are conformed to the transferred patterns 410A, 410B respectively by molding and spin coating.

After the imprint materials 415 are deposited on the template assemblies 402A, 402B, the template assemblies 402A, 402B are brought towards each other with their respective transferred patterns 410A, 410B facing each other. The first and second template assemblies 402A, 402B can be aligned with each other before being brought into contact with each other. For example, the raised patterns 410Aa and 410Ba on the respective template assemblies 402A, 402B are aligned with each other, as is shown in FIG. 4A, resulting in the patterned structure 420 shown in FIG. 4E. Those skilled in the art will appreciate that the template assemblies 402A, 402B can be aligned with each other in various other manners to result in different patterned structures 420, such as that shown in FIG. 4F and described below.

The supporting layer 416 can be provided to assist in forming one or both of the conformed patterns 418A, 418B, as is shown in FIG. 4B. For example, one or both of the template assemblies 402A, 402B can be forced or pressed against the supporting layer 416 to form the conformed patterns 418A, 418B. The supporting layer 416 can be a glass substrate.

As is shown in FIG. 4B, the conformed patterns 418A, 418B, along with the template assemblies 402A, 402B and the supporting layer 416, are subjected to a curing process to stabilize the conformed patterns 418A, 418B. For example, the curing treatment is carried out with the aid of ultraviolet radiation sources 419A, 419B. In another example (not shown), heat sources, similar to the heat source 319′ shown in FIG. 3B, can be employed. In this embodiment, the conformed patterns 418A, 418B on the opposite sides of the supporting layer 416 can be cured at the same time.

During the curing process, the temporary bonding layers 414A, 414B gradually debond from the template assemblies 402A, 402B, so that the carriers 412A, 412B can be separated from their respective templates 408A, 408B, as is shown in FIG. 4C. The conformed patterns 418A, 418B are freed after dissolving the templates 408A, 408B (FIG. 4D) to result in the patterned structure 420 as is shown in FIG. 4E.

The conformed patterns 418A, 418B can be in any of various forms to achieve a patterned structure 420. As is shown in FIG. 4F, the conformed patterns 418A, 418B are formed as convex and concave lenses or microlenses 418A′, 418B′. The convex and concave lenses or microlenses 418A′, 418B′ can be formed on the opposite sides of the supporting layer 416′ or otherwise combined to form a lens or microlens array 420′.

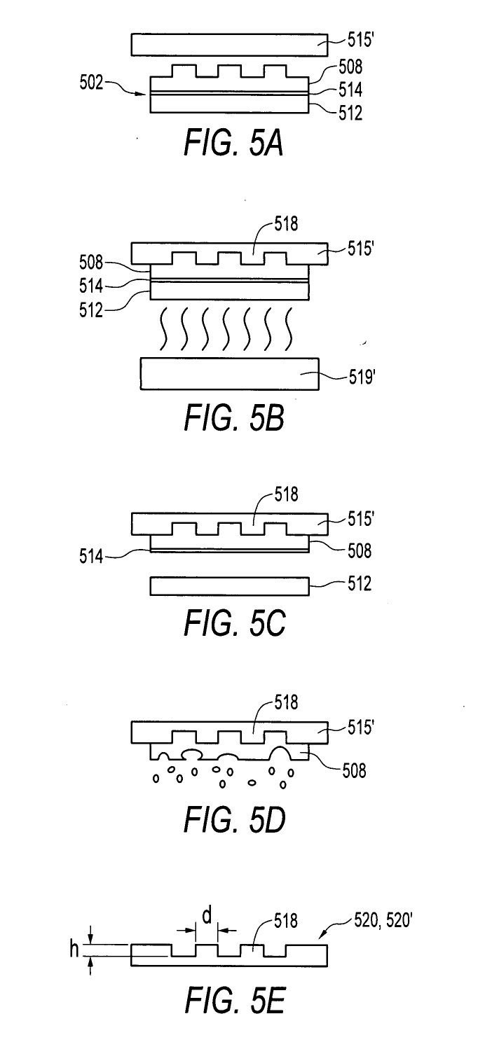

FIGS. 5A to 5E illustrate a fourth embodiment of a method of making a patterned structure 520 (see FIG. 5E). The various components of the patterning device 502 and process steps employed in this embodiment are shown in the figures, but description of the components and process steps similar to those in the above embodiments is omitted.

In this embodiment, the template 508 and the carrier 512 of the patterning device 502 can be formed to withstand heating applied when curing the imprinting material. The bonding layer 514 can be formed of such a thermal releasable adhesive material that, as the imprint material 515 cures, the carrier 512 can be easily released from the template 508.

As FIG. 5A shows, the imprint material is formed as an imprint substrate 515′. The patterning device 502 is brought to and forced into the imprint substrate 515′ and forms the conformed patterns 518 in the imprint substrate 515′, as is shown in FIG. 5B. In one example, an embossing process can be employed to form the conformed patterns 518. The embossing process can be carried out in a heated environment.

FIG. 5B shows that the conformed patterns 518, along with the patterning device 502, are subjected to a heat source 519′ to cure the imprint substrate 515′. During the curing treatment, the thermal release bonding layer 514 debonds from one of the template 508 and the carrier 512, so that the carrier 512 is separated and removed from the template 508 as is shown in FIG. 5C. A template dissolving process (such as the one described above with respect to FIG. 2E) can be used to remove the template 508 from the conformed patterns 518 resulting in the patterned structure 520 (e.g., a lens or microlens array 520′), as is shown in FIG. 5E.

The above described patterned structures 220, 320, 420 can be any of various molecular structures, microstructures, and/or nanostructures, which can be used in various electronics and semiconductor components and devices for electrical, electronic, optical, photonic, biological, material, storage, and other applications. Examples of electronics and semiconductor components and devices include a metal-oxide-semiconductor field-effect transistor (MOSFET), an organic thin-film transistor (O-TFT), a single electron memory, a data storage device, an optical disk (CD), a light emitting diode (LED), a display device, a microlens array, a pixel array, a semiconductor-based imaging device and system as described below, and other components and devices.

FIG. 6 is a block diagram of a CMOS imaging device 501, which has a pixel array 523 containing a patterned structure 220, 320, or 420 (e.g., a lens or microlens array 220′, 320′, or 420′) formed in accordance with one or more embodiments described above. Examples of various CMOS imaging devices, processing steps thereof, and detailed descriptions of the functions of various CMOS elements of a CMOS imaging device are described, for example, in U.S. Pat. No. 6,140,630, U.S. Pat. No. 6,376,868, U.S. Pat. No. 6,310,366, U.S. Pat. No. 6,326,652, U.S. Pat. No. 6,204,524, and U.S. Pat. No. 6,333,205, each of which is assigned to Micron Technology, Inc. The disclosures of each of the forgoing patents are hereby incorporated by reference in their entirety.

The pixel array 523 in the imaging device 501 is formed with pixel cells formed to have various constructions and arranged in a predetermined number of columns and rows. The pixel array 523 can capture incident radiation from an optical image and convert the captured radiation to electrical signals, such as analog signals.

The electrical signals obtained and generated by the pixel array 523 can be read out row by row to provide image data of the captured optical image. For example, pixel cells in a row of the pixel array 523 are all selected for read-out at the same time by a row select line, and each pixel cell in a selected column of the row provides a signal representative of received light to a column output line. That is, each column also has a select line, and the pixel cells of each column are selectively read out onto output lines in response to the column select lines. The row select lines in the pixel array 523 are selectively activated by a row driver 525 in response to a row address decoder 527. The column select lines are selectively activated by a column driver 529 in response to a column address decoder 531.

The imaging device 501 can also comprise a timing and controlling circuit 533, which generates one or more read-out control signals to control the operation of the various components in the imaging device 501. For example, the timing and controlling circuit 533 can control the address decoders 527 and 531 in any of various conventional ways to select the appropriate row and column lines for pixel signal read-out.

The electrical signals output from the column output lines typically include a pixel reset signal (V_{RST}) and a pixel image signal (V_{Photo}) for each pixel cell. In an example of a four-transistor CMOS imaging sensor of the type described and illustrated in the above-referenced U.S. patents, the pixel reset signal (V_{RST}) can be obtained from a corresponding floating diffusion region when it is reset by a reset signal RST applied to a corresponding reset transistor, while the pixel image signal (V_{Photo}) is obtained from the floating diffusion region when photo generated charge is transferred to the floating diffusion region. Both the V_{RST} and V_{Photo} signals can be read into a sample and hold circuit (S/H) 535. In one example, a differential signal (V_{RST}-V_{Photo}) can be produced by a differential amplifier (AMP) 537 for each pixel cell. Each pixel cell's differential signal can be digitized by an analog-to-digital converter (ADC) 539, which supplies digitized pixel data as the image data to be output to an image processor 541. Those skilled in the art would appreciate that the imaging device 501 and its various components can be in various other forms and/or operate in various other ways. In addition, the imaging device 501 illustrated, is a CMOS image sensor, but other types of image sensor cores and associated read out circuits may be used instead.

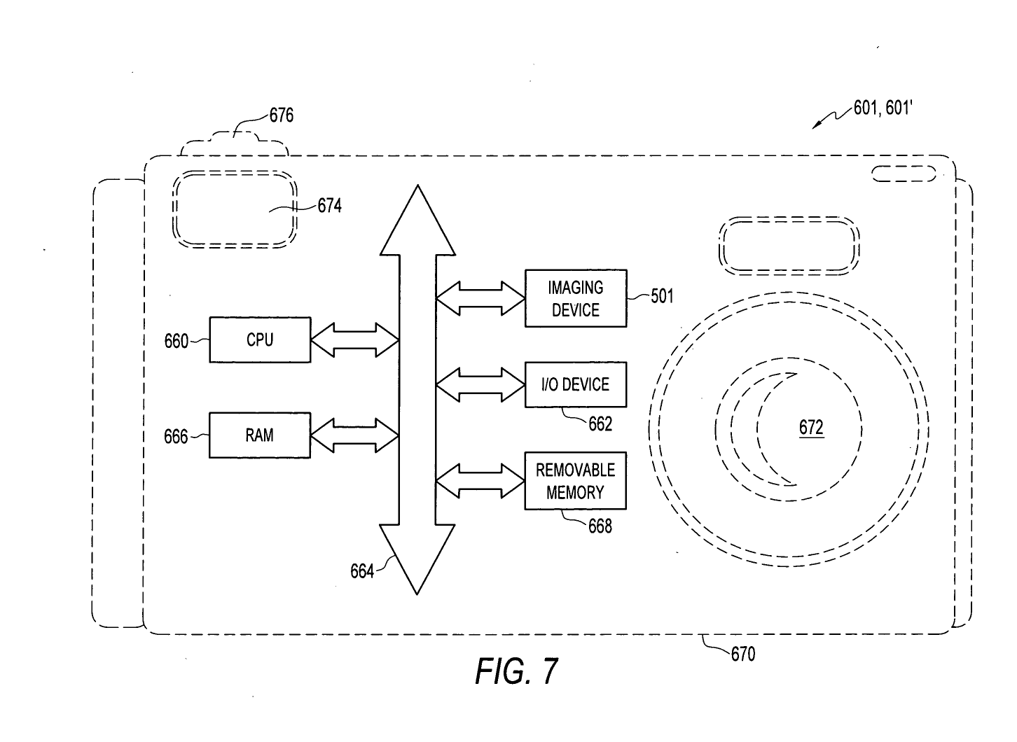

FIG. 7 illustrates a processing system 601 including an imaging device 501 of the type shown in FIG. 6. The imaging device 501 may be combined with a processor, such as a CPU, digital signal processor, or microprocessor, with or without memory storage on a single integrated circuit or on a different chip than the processor. In the example as shown in FIG. 7, the processing system 601 can generally comprise a central processing unit (CPU) 660, such as a microprocessor, that communicates with an input/output (I/O) device 662 over a bus 664. The processing system 601 can also comprise random access memory (RAM) 666, and/or can include removable memory 668, such as flash memory, which can communicate with CPU 660 over the bus 664.

The processing system 601 can be any of various systems having digital circuits that could include the imaging device 501. Without being limiting, such a processing system 601 could include a computer system, a digital camera, a scanner, a machine vision, a vehicle navigation, a video telephone system, a camera mobile telephone, a surveillance system, an auto focus system, a star tracker system, a motion detection system, an image stabilization system, and other systems supporting image acquisition. In the example shown in FIG. 7, the processing system 601 is employed in a digital camera 601′, which has a camera body portion 670, a camera lens 672, a view finder 674, and a shutter release button 676. When depressed, the shutter release button 676 operates the lens 672 and/or imaging device 501 so that light from an image passes through the microlens array 220′ (see, FIG. 2F) and is captured by the pixel array 523 (see, FIG. 6). As those skilled in the art will appreciate, the imaging device 501, the processing system 601, the camera system 601′ and other various components contained therein can also be formed and/or operate in various other ways.

It is again noted that although the above embodiments are described with reference to a complementary metal-oxide-semiconductor (CMOS) imaging device, they are not limited to CMOS imaging devices and can be used with other solid state imaging device technology (e.g., CCD technology) as well.

It will be appreciated that the various features described herein may be used singly or in any combination thereof. Therefore, the embodiments are not limited to the embodiments specifically described herein. While the foregoing description and drawings represent examples of embodiments, it will be understood that various additions, modifications, and substitutions may be made therein as defined in the accompanying claims. In particular, it will be clear to those skilled in the art that other specific forms, structures, arrangements, proportions, materials can be used without departing from the essential characteristics thereof. The presently disclosed embodiments are therefore to be considered in all respects as illustrative and not restrictive.

What is claimed as new and desired to be protected by Letters Patent of the United States is:

1. A method of making a patterned structure, the method comprising:
patterning a material to conform to a template pattern on a template, the template being supported on a carrier during the patterning step through a releasable medium;
curing the patterned material while at least partially releasing the releasable medium from at least one of the carrier and the template; and
removing the template from the patterned material to obtain the patterned structure.

2. The method of claim 1, wherein the releasable medium comprises a releasable adhesive material.

3. The method of claim 1, wherein the patterned material forms a lens structure.

4. The method of claim 1, wherein the patterning step comprises jet coating the material over the template.

5. The method of claim 1, wherein the material to be patterned is in the form of a substrate and the patterning step comprises embossing the substrate.

6. The method of claim 1, wherein the curing step comprises subjecting the patterned material to ultraviolet radiation.

7. The method of claim 1, wherein the curing step comprises subjecting the patterned material to a heat treatment.

8. The method of claim 1, wherein the removing step comprises dissolving the template in a solvent.

9. The method of claim 1 further comprising providing a pattern supporting layer having opposite sides, wherein the patterned material is formed on at least one of the opposite sides of the pattern supporting layer.

10. The method of claim 9, wherein the patterning step comprises forming at least one of convex and concave patterns on the pattern supporting layer.

11. The method of claim 9, wherein the pattern supporting layer is formed of a glass material.

12. The method of claim 9, wherein the pattern supporting layer is a wafer substrate and the patterning step comprises forming patterned materials across substantially the entire wafer substrate.

13. The method of claim 12, wherein the wafer substrate is divided by a plurality of dies and the patterning step comprises forming a plurality of patterns within each die on the wafer substrate.

14. The method of claim 9, wherein the patterning step comprises forming an array of microstructures on at least one of the opposite sides of the pattern supporting layer.

15. The method of claim 9, wherein the patterning step comprises forming an array of nanostructures on at least one of the opposite sides of the pattern supporting layer.

16. The method of claim 9, wherein the patterning step comprises forming patterned materials on each of the opposite sides of the pattern supporting layer.

17. The method of claim 16, wherein the patterning step comprises forming a plurality of convex patterns on one side of the pattern supporting layer and forming a plurality of concave patterns on the opposite side of the pattern supporting layer.

18. The method of claim 17, wherein the curing step comprises simultaneously curing the patterned materials on the opposite sides of the pattern supporting layer.

19. The method of claim 17, wherein the removing step comprises simultaneously removing the templates from the patterned materials on the opposite sides.

20. A method of forming a patterned structure, the method comprising:
patterning first and second materials to conform respectively to first and second template patterns on first and second templates, so that the patterned first and second materials form replicas of respectively the first and second template patterns, each template being releasably supported by a carrier during the patterning step;
bringing the patterned first and second materials together to assemble a patterned structure;
curing the patterned first and second materials while at least partially separating the carriers from the templates; and
removing the first and second templates from the patterned first and second materials to obtain the patterned structure.

21. The method of claim 20, wherein the patterning step comprises jet coating the first and second materials over the first and second templates.

22. The method of claim 20 further comprising providing a pattern supporting layer having opposite sides, wherein the patterned first and second materials are supported on the opposite sides of the pattern supporting layer.

23. The method of claim 22, wherein the patterning step comprises patterning the first and second materials to form a plurality of convex patterns and a plurality of concave patterns, respectively.

24. The method of claim 20, wherein the curing step comprises simultaneously curing the patterned first and second materials.

25. The method of claim 20, wherein the removing step comprises simultaneously removing the first and second templates from the patterned first and second materials.

26. A method of forming a lens structure, the method comprising:
patterning a lens material to conform to a template pattern on a template which is releasably supported on a carrier, the template pattern defining at least a portion of a lens structure;
curing the patterned lens material while at least partially separating the carrier from the template; and
removing the template from the patterned lens material to obtain the lens structure.

27. The method of claim 26, wherein the lens structure comprises at least one image objective lens.

28. The method of claim 26, wherein the lens structure comprises at least one microlens array.

29. The method of claim 26 further comprising providing a pattern supporting layer having opposite sides, wherein the patterned lens material is formed on at least one of the opposite sides of the pattern supporting layer.

30. The method of claim 26, wherein the patterning step comprises forming a plurality of convex lens patterns on one side of the pattern supporting layer.

31. The method of claim 30, wherein the patterning step further comprises forming a plurality of concave lens patterns on the opposite side of the pattern supporting layer.

32. The method of claim 31, wherein the curing step comprises simultaneously curing the patterned lens materials on the opposite sides of the pattern supporting layer.

33. A method of forming an imaging device having a patterned lens structure, the method comprising:
patterning a lens material to conform to a template pattern on a template, the template being supported on a carrier during the patterning step;
curing the patterned lens material while at least partially separate the carrier from the template;
removing the template from the patterned material to obtain a patterned lens structure; and
incorporating the patterned lens structure over a pixel array of the imaging device.

34. The method of claim 33, wherein the patterning step comprises forming at least one image objective lens.

35. The method of claim 33, wherein the patterning step comprises forming at least one microlens array.

36. The method of claim 33 further comprising providing a pattern supporting layer having opposite sides, wherein the patterned lens material is formed on both opposite sides of the pattern supporting layer.

37. The method of claim 36, wherein the patterned materials on the opposite sides of the pattern supporting layer are cured simultaneously.

38. A method of forming a patterning device, the method comprising:
forming a template having a replica of a master pattern on a master;
joining the template to a carrier using material releasable in the presence of a releasing source; and
separating the joined template and carrier from the master to provide the patterning device;
wherein the template is at least partially detachable from the carrier when the patterning device is subjected to a releasing agent.

39. The method of claim 38, wherein the joining step comprises applying an adhesive material to at least one of the template and the carrier.

40. The method of claim 39, wherein the template and the carrier are formed of materials transparent to ultraviolet radiation.

41. The method of claim 38, wherein the step of forming a template comprises forming a plurality of recessed patterns and the recessed patterns are each formed as at least one of convex and concave patterns.

42. A patterning device comprising:
a template comprising a replica of a master pattern;
a carrier for supporting the template; and
an adhesive material releasably attaching the template the carrier and releasing the attached carrier and template in the presence of a releasing source.

43. The patterning device of claim 42, wherein the adhesive material comprises an ultraviolet release material.

44. The patterning device of claim 42, wherein the adhesive material comprises a thermal release material.

45. The patterning device of claim 42, wherein the adhesive material is a preformed adhesive tape.

46. The patterning device of claim 42, wherein the template comprises a plurality of convex recessed patterns for forming concave patterned structures.

47. The patterning device of claim 42, wherein the template comprises a plurality of concave recessed patterns for forming convex patterned structures.

48. The patterning device of claim 42, wherein the template comprises a material dissolvable in a solution.

49. The patterning device of claim 42, wherein the template and the carrier are formed of materials transparent to ultraviolet radiation.

50. The patterning device of claim 42, wherein the carrier comprises a glass material.

51. The patterning device of claim 42 comprising first and second template assemblies each being formed by the releasably attached template and carrier, wherein the first and second template assemblies comprise respectively first and second replicas defining the patterned structure, which the patterning device is capable of replicating.

52. The patterning device of claim 51, wherein the first and second replicas differ from each other.

53. The patterning device of claim 42 further comprising a supporting layer for supporting the patterned structure thereon.
